(19) United States
(12) Patent Application Publication
(10) Pub. No.: US 2015/0220921 A1
(43) Pub. Date: Aug. 6, 2015

(54) Codes Providing Authentication and Additional Functionality

(71) Applicant: Bank of America Corporation, Charlotte, NC (US)

(72) Inventors: Nathan Dent, Concord, NC (US); James David Freedman, Charlotte, NC (US); David Grigg, Rock Hill, SC (US)

(21) Appl. No.: 14/172,260

(22) Filed: Feb. 4, 2014

(51) Int. Cl. G06Q 20/40; G06Q 20/22

(52) U.S. Cl. CPC G06Q 20/40; G06Q 20/22

(57) ABSTRACT

Systems, methods and apparatuses for authenticating a user via a machine-readable code arranged on a reusable payment device and a computing device are provided. An image of the machine-readable code may be received from a computing device, such as a mobile device. If it is determined that a match exists between a user associated with the mobile device and a user associated with the machine-readable code and/or reusable payment device, a user may be authenticated and may be provided with account information and/or account functionality. In some examples, the authentication may be used to pre-populate payment information during a transaction.

### BACKGROUND

Maintaining privacy and security of personal information is important to people today. With the ever-increasing number of online or electronic based transactions, the opportunity for unauthorized access to a user's personal information, financial information, and the like, increases. Accordingly, additional security measures to maintain the privacy of personal information are often being implemented. However, in some arrangements, additional security measures can create cumbersome procedures or processes for users to implement. For instance, requiring multiple forms of identification or authentication in order to access information or functionality can be inefficient and inconvenient for a user.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, and apparatuses for receiving an image of a machine-readable code arranged on a reusable payment device, such as a credit or debit card. The image may be received from a computing device, such as a mobile device. An identifier associated with the computing device may also be received. If it is determined that a match exists between a user associated with the mobile device and a user associated with the machine-readable code and/or reusable payment device, a user may be authenticated and may be provided with account information and/or account functionality. The information or functionality may be provided responsive to a request received from the user. In some arrangements, the receipt of the machine-readable code from the device associated with the user may be sufficient to authenticate the user and no additional authentication (e.g., no username, password, or the like) may be needed to authenticate the user.

Additional aspects may be directed to authentication of a user via the machine-readable code and computing device to provide payment or payment information during a transaction. For instance, a user may be attempting to make a payment using the reusable payment device. The image of the machine-readable code may be received from the computing device and the user may be authenticated based on a match between the user associated with the computing device and the user associated with the reusable payment device. In some examples, payment information from an account associated with the reusable payment device may then be pre-populated as the billing information for use in payment during the transaction. In some examples, a proxy number may be generated and provided as payment information instead of the account number associated with the reusable payment device.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 is an illustrative block diagram of workstations and servers that may be used to implement the processes and functions of certain aspects of the present disclosure according to one or more aspects described herein.

FIG. 3 illustrates an example authentication and functionality providing code system according to one or more aspects described herein.

FIG. 4 is an example reusable payment device including a machine-readable code according to one or more aspects described herein.

FIG. 5 illustrates an example method of authenticating a user and providing functionality according to one or more aspects described herein.

FIG. 6 is another example method of authenticating a user and providing functionality according to one or more aspects described herein.

FIG. 7 illustrates yet another example method of authenticating a user and providing functionality according to one or more aspects described herein.

FIG. 8 illustrates an example user interface displaying account information according to one or more aspects described herein.

FIG. 9 illustrates an example user interface providing additional functionality to a user according to one or more aspects described herein.

FIG. 10 illustrates one example user interface displaying pre-populated payment information according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

It is noted that various connections between elements are discussed in the following description. It is noted that these connections are general and, unless specified otherwise, may be direct or indirect, wired or wireless, and that the specification is not intended to be limiting in this respect.

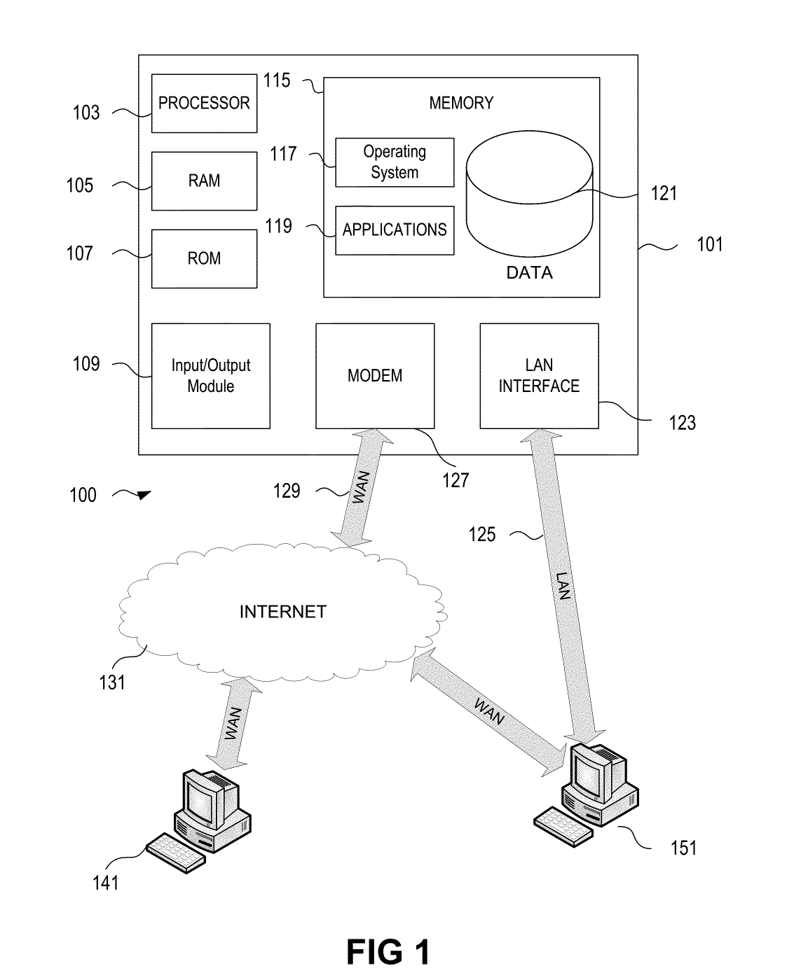

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed arrangements is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141 and 151. Computing devices 141 and 151 may be personal computing devices or servers that include any or all of the elements described above relative to computing device 101. Computing devices 141 or 151 may be a mobile device (e.g., smart phone) communicating over a wireless carrier channel.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

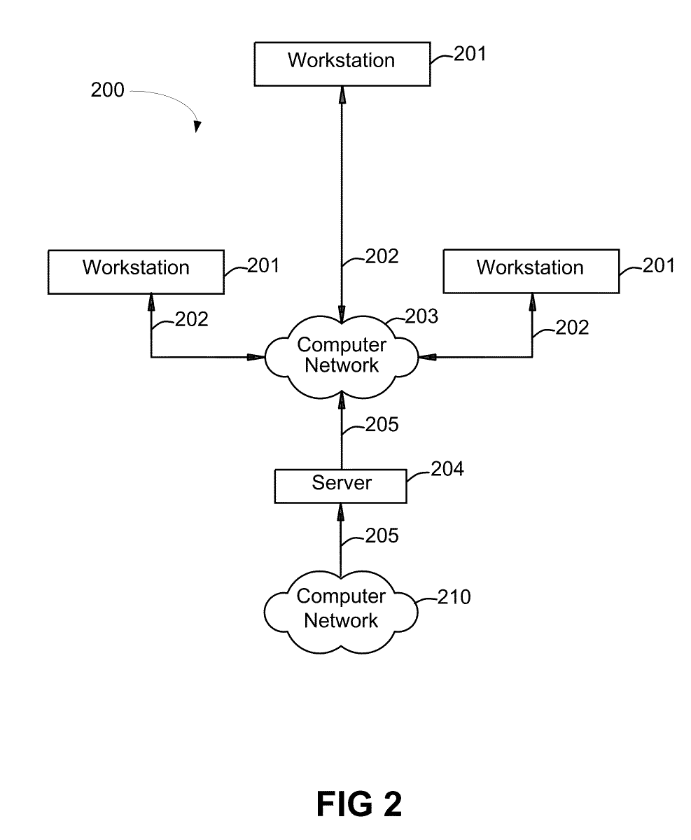

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204 (e.g. network control center), such as network links, dial-up links, wireless links, hard-wired links, as well as network types developed in the future, and the like. A virtual machine may be a software implementation of a computer that executes computer programs as if it were a standalone physical machine.

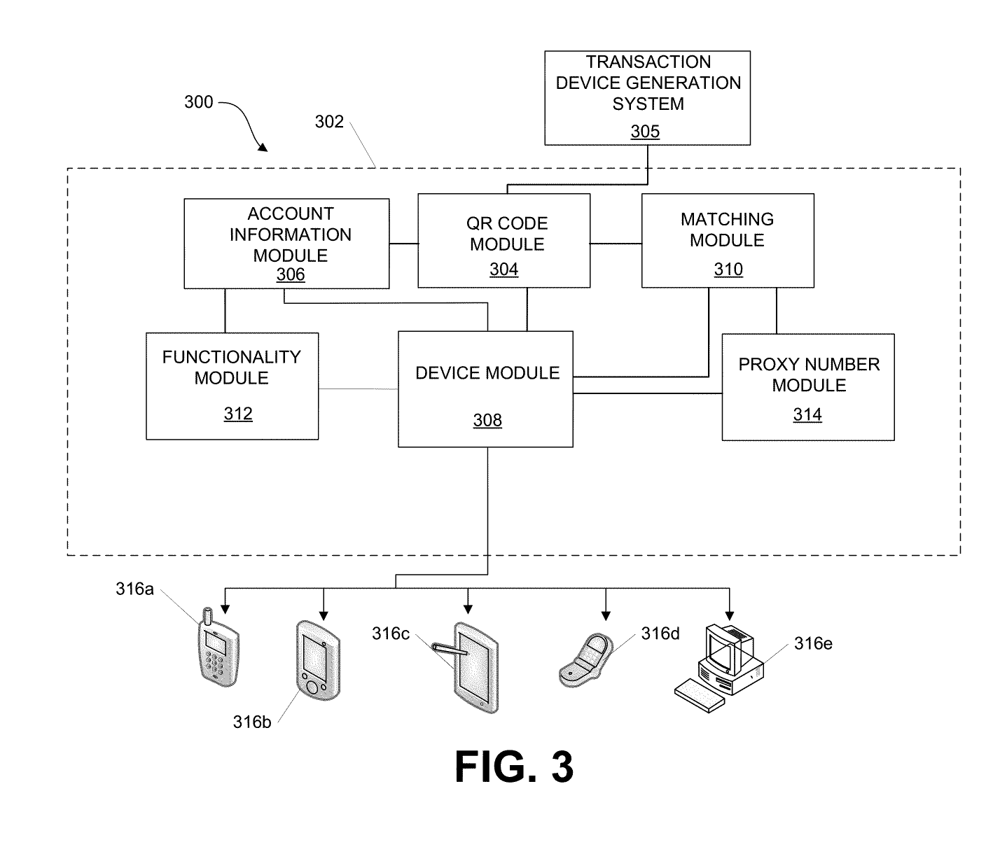

FIG. 3 illustrates one example authentication and functionality providing code system 300 according to one or more aspects described herein. In some examples, the authentication and functionality providing code system 300 may be part of, internal to or associated with an entity 302. The entity 302 may be a corporation, university, government entity, and the like. In some examples, the entity 302 may be a financial institution, such as a bank. Although various aspects of the disclosure may be described in the context of a financial institution, nothing in the disclosure shall be construed as limiting the authentication and functionality providing code system 300 to use within a financial institution. Rather, the system 300 may be implemented by various other types of entities.

The authentication and functionality providing code system 300 may include one or more modules that may include hardware and/or software configured to perform various functions within the system 300. For instance, the system, 300 may include a machine-readable code module 304. The machine-readable code module 304 may generate one or more machine-readable codes, such as quick response (QR) codes, bar codes, and the like, for use on a reusable payment device, such as a debit or credit card. The machine-readable codes may include or store information associated with an account associated with the reusable payment device and/or a user associated with the reusable payment device. The machine-readable code and/or the information stored thereon or contained therein may be used in a variety of ways, including for payment during a transaction, and/or as authentication of a user or device of a user, as will be discussed more fully below. In some examples, the machine-readable code may be scanned or read, such a via a computing device 316a-316e, to provide additional functionality, as will be described more fully below.

In some examples, the machine-readable code module 304 may be connected to or in communication with one or more account information modules 306. The account information module may include or store (e.g., via a database) information associated with one or more users and/or user accounts. For instance, the account information module 306 may include information such as an account number associated with a reusable payment device, a user associated with a reusable payment device, a routing number of an account associated with the reusable payment device, an expiration date of the reusable payment device, and the like. In some examples, some or all of this information may be transmitted to the machine-readable code module 304 and may be included in a machine-readable code generated for a reusable payment device.

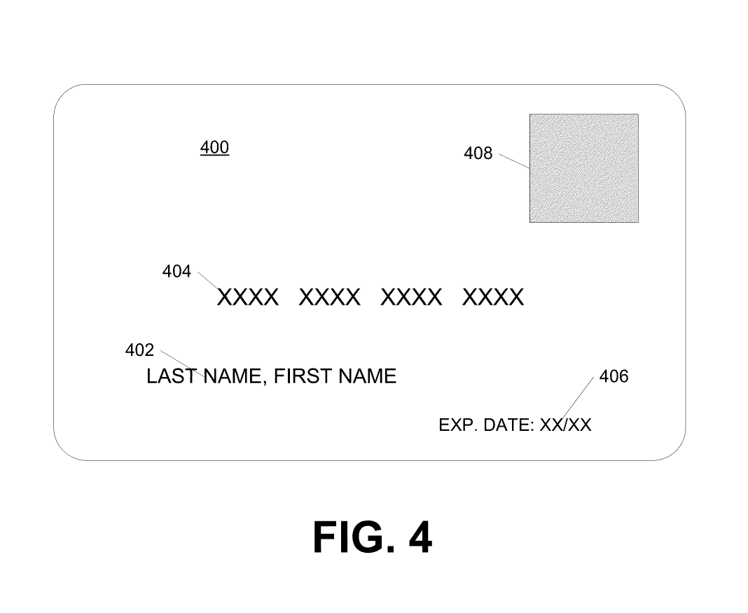

In some arrangements, the machine-readable code may be printed on the reusable payment device, such as a credit or debit card. The production of the reusable payment device, including the machine-readable code, may be performed by a separate system, such as reusable payment device generation system 305. FIG. 4 illustrates one example reusable payment device that may be used in conjunction with the arrangements described herein. The reusable payment device 400 may be a debit card, credit card, or the like, and may, in some examples, such as shown in FIG. 4, include information found on conventional transactions devices. In other examples, one or more portions of the information typically found on conventional reusable payment devices (e.g., expiration date, name, account number, and the like) may be omitted from the reusable payment device for additional security purposes.

The reusable payment device 400 includes a name 402 and an account number 404 of the account associated with the reusable payment device 400 (e.g., credit account, checking account, and the like). The reusable payment device 400 may further include an expiration date 406 of the reusable payment device 400. Further, the reusable payment device 400 may include a machine-readable code 408, such as a QR code, bar code, and the like, that may contain information related to an account associated with the reusable payment device 400, such as account number 404, user associated with the account 402, expiration date 406, and the like. This information may be used, obtained from the machine-readable code 408, may be used to provide additional functionality to a user, provide payment during a transaction and/or to authenticate a user or device, as will be discussed more fully below.

With further reference to FIG. 3, the machine-readable code module 304 may also be configured to “read” a machine-readable code, such as a QR code, transmitted to the system 300. As will be discussed more fully below, a computing device may capture a machine-readable code from a reusable payment device and transmit the information to the system. The machine-readable code may be “read” by the machine-readable code module 304 and may then be further processed, as discussed herein.

The authentication and functionality providing code system 300 may include a device module 308. The device module 308 may receive, such as from one of computing devices 316a-316d, a scan of a machine-readable code, such as code 408 on reusable payment device 400. In some examples, the computing device may be a mobile device, such as a smartphone 316a, personal digital assistant 316b, tablet computer 316c, or cell phone 316d. Accordingly, the device may capture an image of the machine-readable code and device module 318 may receive the code or image of the code. Information associated with an identifier of the device capturing the image may also be received with the machine-readable code and the device module 308 may be configured to communicate with the machine-readable code module 304 to “read” the information contained within the machine-readable code.

Matching module 310 may determine whether the received machine-readable code and/or a user associated therewith is associated with the received identifier of the device capturing the code. If so, that may indicate that a user of the reusable payment device including the machine-readable code is attempting to access information, such as via their mobile device, and may provide an authentication of the user. Accordingly, if the user associated with the machine-readable code is also associated with the identifier of the device capturing the machine-readable code, additional functionality, access, and the like may be provided to the user. In some examples, this additional access, functionality, and the like, may be provided without requiring any additional authentication of the user. Stated differently, the capturing of the machine-readable code associated with the user by a device associated with the user may be sufficient to authenticate the user.

In some examples, the matching module 310 may include one or more data stores or databases containing one or more tables, such as look-up tables. The tables may include information associated with various accounts (e.g., account numbers, routing numbers, and the like), various users (e.g., names, addresses, birthdates, phone numbers, and the like), and/or various computing devices (e.g., mobile devices, and the like). For instance, a user may register his or her mobile device or mobile device number. This information may be associated with the user and may then be used in authenticating the user, as described herein. In other examples, registration of the computing device might not be performed. Rather, use of a device, such as a mobile device, by a user, to, for instance, access mobile banking, make payments, or the like, a threshold number of times may be sufficient for the system 300 to obtain an identifier associated with the computing device and store it in association with the user.

The authentication and functionality providing code system 300 may further include a functionality module 312. The functionality module 312 may receive input from the matching module indicating that a match between the machine-readable code and the device capturing the code exists and thus a user is authenticated. Accordingly, the functionality module 312 may determine one or more functions to provide to a user and transmit those functionalities to the user. In some examples, the functionality provided may be more than or additional to typical functionality provided to a user. For instance, a user authenticating by means other than the machine-readable code and device match described herein may be provided functionality A, B, and C, while a user authenticating via the machine-readable code and device match may be provided functionality A, B, C, D, and E. The match between the machine-readable code and the device capturing the code provides additional confidence in the authentication of the user because the code is captured from a reusable payment device and the likelihood of an unauthorized user having both the reusable payment device (including the machine-readable code) and the mobile device (to capture the code) associated with the user is low.

In some examples, the functionality module 312 may identify functionalities such as providing account balance information, providing account limits, providing interest rates associated with one or more accounts or loans, providing transaction history, and the like. Additionally or alternatively, the functionality module 312 may identify and/or provide functionality such as permitting a user to set a travel flag or warning (e.g., when a user is travelling to another country, the user may identify the country to avoid potential unauthorized access warnings associated with transactions performed while travelling), requesting a replacement reusable payment device or an additional reusable payment device, activating the reusable payment device, deactivating the reusable payment device (e.g., when the device will not be in use, the user may temporarily deactivate the reusable payment device to avoid unauthorized use), and the like. In still other examples, the functionality module 312 may provide payment information. For instance, if the reusable payment device is being used as a form of payment in a transaction, the match between the machine-readable code and the device may prompt the functionality module 312 to pre-populate payment information, such as account number, name, expiration date, and the like, in order to simplify the transaction process.

The authentication and functionality providing code system 300 may further include a proxy number module 314. In some examples, the proxy number module 314 may generate a proxy number to be used in place of the actual account number of the user, for additional security. That is, if the reusable payment device is being used as a form of payment during a transaction, upon determining that a match exists between the machine-readable code and the device capturing the code, the proxy number module may generate a proxy number to be pre-populated as payment information instead of the actual account number of the user. This may aid in maintaining the privacy of the user since the actual account number is not being provided but rather a temporary proxy number is provided that is linked to the actual account number and/or account information of the user.

The authentication and functionality providing code system 300 may be connected to or in communication with various computing devices, such as devices 316a-316e. The computing devices may include various types of devices, such as a smartphone 316a, PDA 316b, tablet computer 316c, cell phone 316d or other terminal or computing device 316e. The computing devices 316a-316e may be connected to or in communication with the system 300 in order to capture a machine-readable code and/or receive or provide the functionality to the user. Additionally or alternatively, a user, such as an administrator, may access one or more modules of the system 300 to update information, adjust or modify operation of the system, and the like, via the one or more computing devices 316a-316e.

These and various other arrangements will be discussed more fully below.

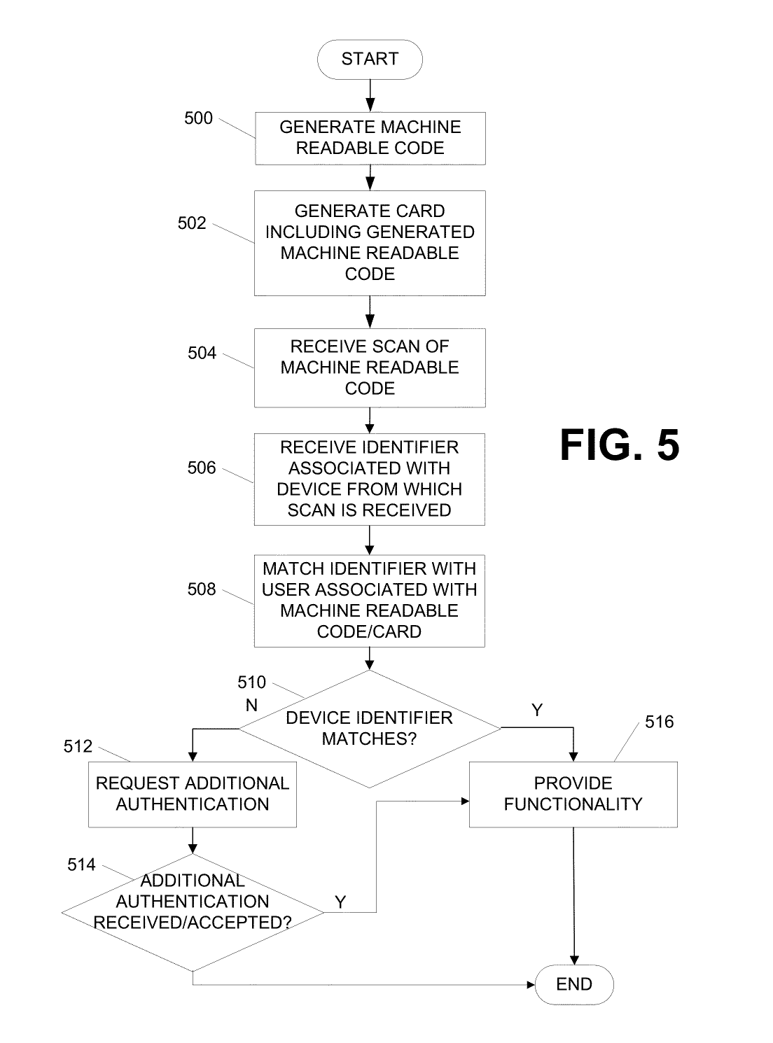

FIG. 5 illustrates one example method of using a machine-readable code on a reusable payment device, such as a debit or credit card, to provide authentication of a user and/or additional functionality to a user. In step 500, a machine-readable code, such as a QR code, may be generated. The machine-readable code may include information related to an account associated with the reusable payment device, a user of the reusable payment device, and the like. In step 502, a reusable payment device, such as a debit or credit card, may be generated including the machine-readable code. The machine-readable code may be arranged on any side and/or in any region of the reusable payment device. For instance, the machine-readable code may be arranged on a front facing side of the reusable payment device and in a corner of the reusable payment device.

It should be noted that, although the method described in FIG. 5 begins with steps 500 and 502, in some examples, the method may also begin at step 504, in which the machine-readable code and reusable payment device have already been generated.

In step 504, a scan of the machine-readable code on the reusable payment device is received, such as by system 300. In step 506, an identifier associated with a computing device capturing and/or transmitting the machine-readable code is also received. For instance, a user may desire to access account information via his or her mobile device. Accordingly, the user may request the information and, as authentication, capture the machine-readable code from his or her reusable payment device and transmit, from the mobile device capturing the machine-readable code, the machine-readable code or image thereof, as well as identifying information associated with the mobile device.

In step 508, the system may determine whether the device from which the machine-readable code was captured and/or from which the information was transmitted is associated with a user associated with the reusable payment device associated with the machine-readable code. For instance, continuing the example above, the system may determine whether the user associated with the mobile device used to capture and transmit the machine-readable code or image thereof, matches a user associated with the reusable payment device on which the machine-readable code is arranged or with which the machine-readable code is associated.

In step 510, a determination is made as to whether a match exists. If so, additional functionality may be provided to the user in step 516. For instance, the user may be provided access to account information, such as an account balance, interest rate, credit limit, transaction history, and the like. This information may be provided to the user via the computing device capturing the machine-readable code. Accordingly, the matching of the user associated with the reusable payment device and the mobile device provides authentication of the user which then permits access to the additional functionality. In some examples, no additional authentication is needed to provide the user with the additional functionality.

In some examples, the additional functionality provided may include permitting a user to set a travel flag, activate or deactivate the reusable payment device, request a replacement reusable payment device or an additional reusable payment device, receive promotions or other incentives for use in a retail establishment, and the like.

If, in step 510, a match does not exist between the user associated with the reusable payment device and the mobile device, in step 512, additional authentication may be requested. For instance, the user may be prompted to input additional identifying information, such as a username or other identifier, password, personal identification number, birthdate, and the like.

In step 514, a determination is made as to whether additional authenticating information has been received. If so, the additional functionality may be provided to the user in step 516. Alternatively, if additional authenticating information is not received, or if the information received is incorrect or does not match pre-stored identifying data (e.g., a pre-stored PIN number, password, or the like), the process may end.

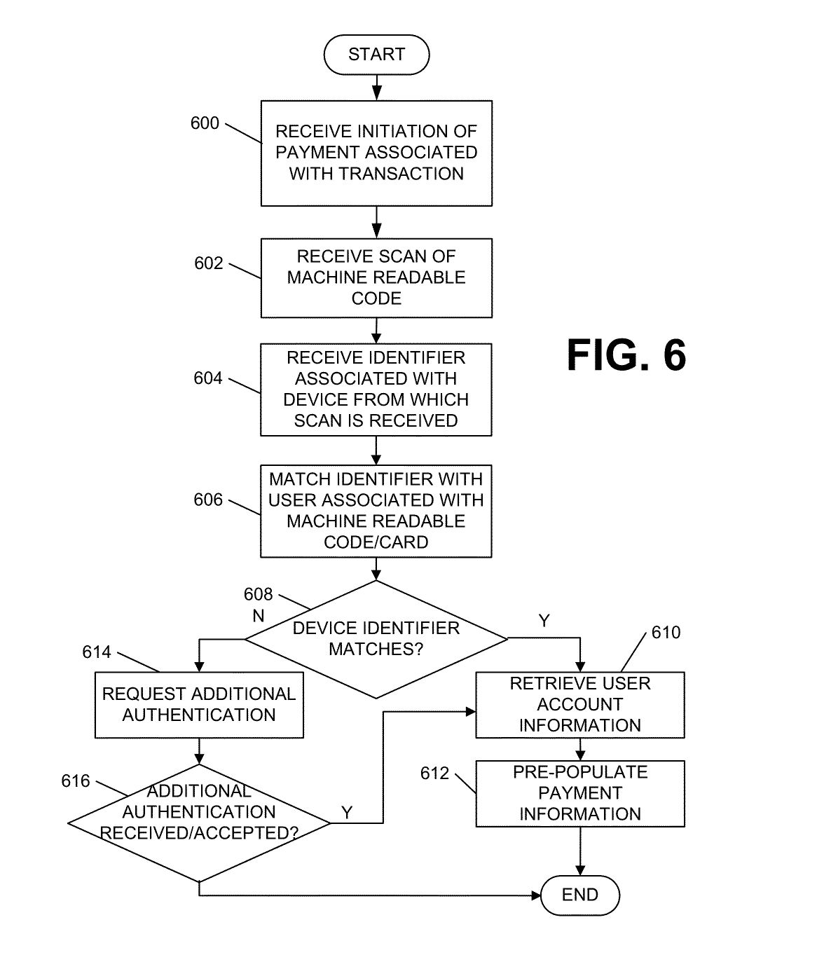

FIG. 6 illustrates another example method of using a machine-readable code on a reusable payment device, such as a debit or credit card, to provide authentication of a user and/or additional functionality to a user. In step 600, a payment is initiated with a reusable payment device including a machine-readable code and information associated with the initiated payment is received by the system (e.g., system 300). For instance, a user may be using his or her debit or credit card to make a purchase online. In step 602, a scan or image of the machine-readable code from the reusable payment device is received by the system. The image may be captured via a computing device, such as computing devices 316a-316e in FIG. 3. In step 604, information identifying the computing device is received. For instance, in the case of a mobile device, the international mobile equipment identity (IMEI) of the device may be transmitted to the system. In step 606, an attempt is made to match the identifier of the computing device or the user associated therewith, with a user associated with the reusable payment device from which the machine-readable code was captured. In step 608, a determination is made as to whether a match exists.

If, in step 608, a match does exist, user account information associated with the reusable payment device may be retrieved. For instance, an account number, expiration date, card verification value (CVV) or the like, may be retrieved. This information may be retrieved from the machine-readable code and/or from one or more databases storing the information (such as account information module 306 in FIG. 3) that may be linked to the machine-readable code. In step 612, payment information associated with the reusable payment device may be pre-populated for the payment or billing information requested to complete the transaction. For instance, if the transaction is an online payment, the account number, expiration date, CVV number, name, billing address, and the like, may be pre-populated for the user, based on the authentication provided by the match between the machine-readable code and associated user and the mobile device and the associated user.

If, in step 608, a match does not exist, additional authentication may be requested in step 614. For instance, the user may be prompted to input additional identifying information, such as a username or other identifier, password, personal identification number, birthdate, and the like.

In step 616, a determination is made as to whether additional authenticating information has been received. If so, the process may continue at step 610. Alternatively, if additional authenticating information is not received, or if the information received is incorrect or does not match pre-stored identifying data (e.g., a pre-stored PIN number, password, or the like), the process may end.

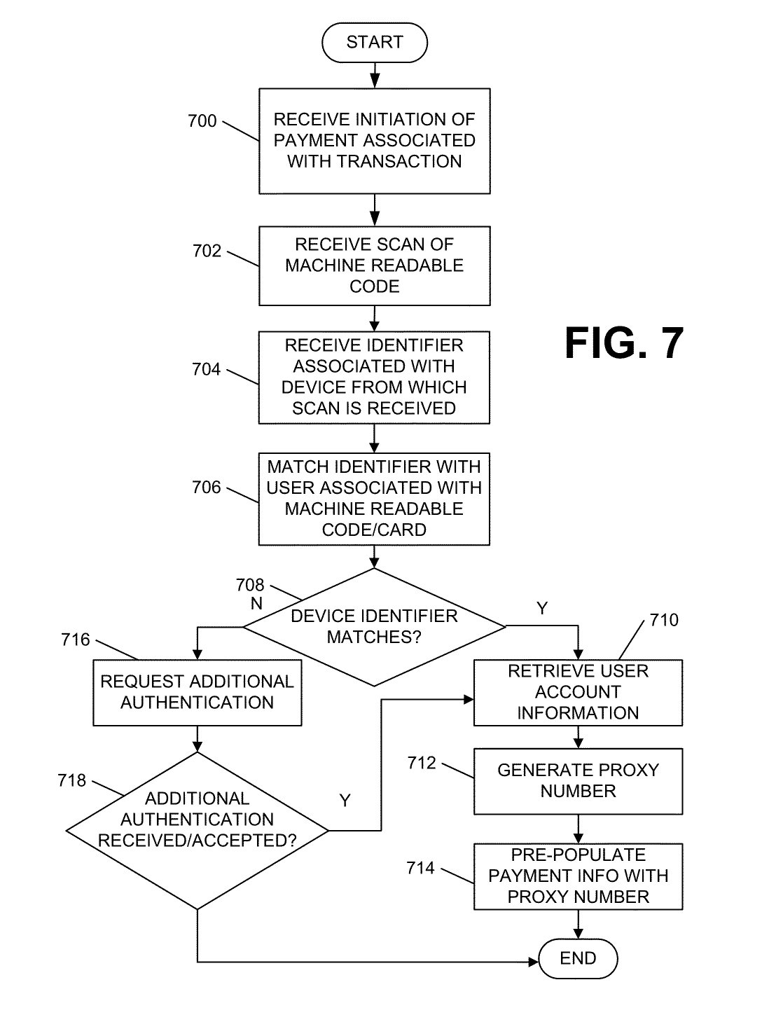

FIG. 7 illustrates yet another example method of using a machine-readable code on a reusable payment device, such as a debit or credit card, to provide authentication of a user and/or additional functionality to a user. Similar to steps 600-606, the process begins at step 700 with the initiation of a transaction or payment associated with the transaction. In step 702, a scan of a machine-readable code on a reusable payment device is received and in step 704, an identifier associated with a computing device capturing the machine-readable code from the reusable payment device is received.

In step 706, an attempt is made to match a user associated with the computing device with a user associated with the machine-readable code and/or reusable payment device as, for instance, a method of authenticating the user attempting to make the payment or complete the transaction. In step 708, a determination is made as to whether a match exists. If so, in step 710, user account information may be retrieved, similar to step 610. In step 712, a proxy number may be generated. The proxy number may be generated by the system (e.g., proxy number module 314 in system 300 in FIG. 3). The proxy number may be linked to an account number or information associated with an account number of the reusable payment device. However, the proxy number may be a temporary number that may be used to make a payment or complete a transaction using funds from the account (or credit associated with the account) of the reusable payment device without disclosing the actual account number. This may add an additional level of security for a user because the user need not disclose the account number in order to complete the transaction. Rather, the user may provide the proxy number, which may be available for one-time or limited use.

In step 714, payment information may be pre-populated with the proxy number. For instance, any payment information may be pre-populated with a user's name, billing address, and the like, but instead of the actual account number, the proxy number may be provided. Authentication of the user based on the match between the machine-readable code and device capturing the code may initiate or permit this generation of the proxy number and use during the transaction.

If, in step 708, a match does not exist, additional authenticating information may be requested in step 716. In step 718, a determination is made as to whether the additional authenticating information has been received and/or accepted. If so, the process may continue at step 710. Alternatively, if no additional authenticating information is received, or if it is not accepted (e.g., incorrect password, or the like), the process may end.

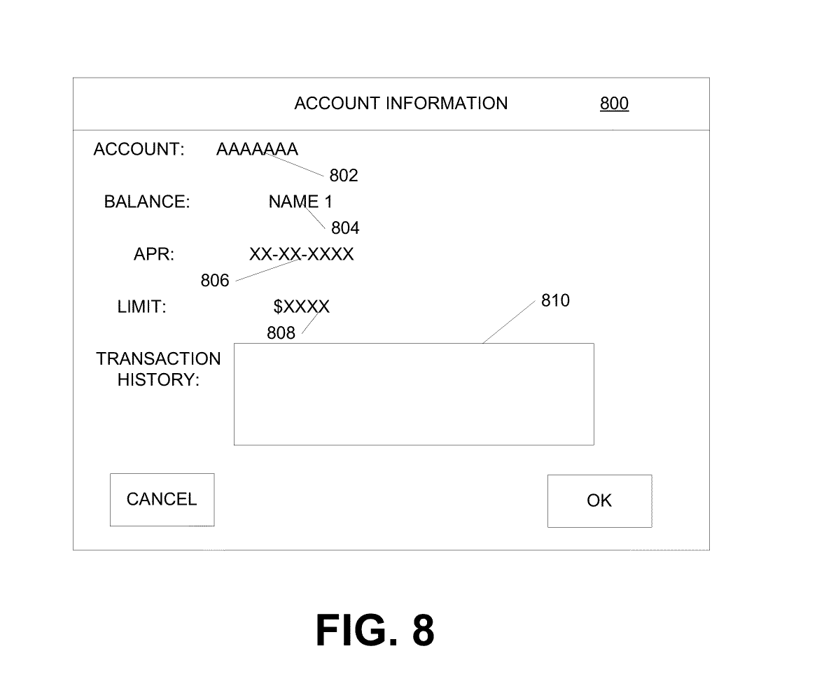

FIGS. 8-10 illustrate various user interfaces that may be provided to a user based on the authentication process described herein. The interfaces may include various additional functionalities provided to a user based on the authentication. The user interfaces may be provided on any type of computing device, such as a mobile device (e.g., smartphone, cell phone, and the like), tablet computer, laptop computer, desktop computer, and the like.

FIG. 8 illustrates one example user interface 800 providing account information based on the authentication of the user. For instance, a user may capture a machine-readable code on a reusable payment device using his or her mobile device. As discussed above, a determination may be made as to whether the user associated with the mobile device matches the user associated with the machine-readable code and/or reusable payment device associated with the machine-readable code. If so, a user may be authenticated and may be provided with, for example, the account information illustrated in user interface 800.

In some examples, the information may be provided responsive to a request received from the user. For instance, the user may be attempting to access account information via a mobile device (e.g., via a mobile banking application). Upon receiving the request, the user may be prompted to scan the machine-readable code with the mobile device. The system may then authenticate the user by matching the user of the mobile device with the user of the reusable payment device from which the machine-readable code was scanned. If a match exists, the requested information may be provided to the user.

The interface 800 may include an account number 802, as well as a name of a user associated with the account in field 804. The interface 800 may further include the annual percentage rate (APR) for the account in field 806 and/or a credit limit in field 808. In some examples, the interface 800 may include a transaction history field 810 in which a user may view recent or previous transactions. The information displayed in interface 800 are merely some examples of the account information that may be provided. Additional account information may be provided in user interface 800 without departing from the invention.

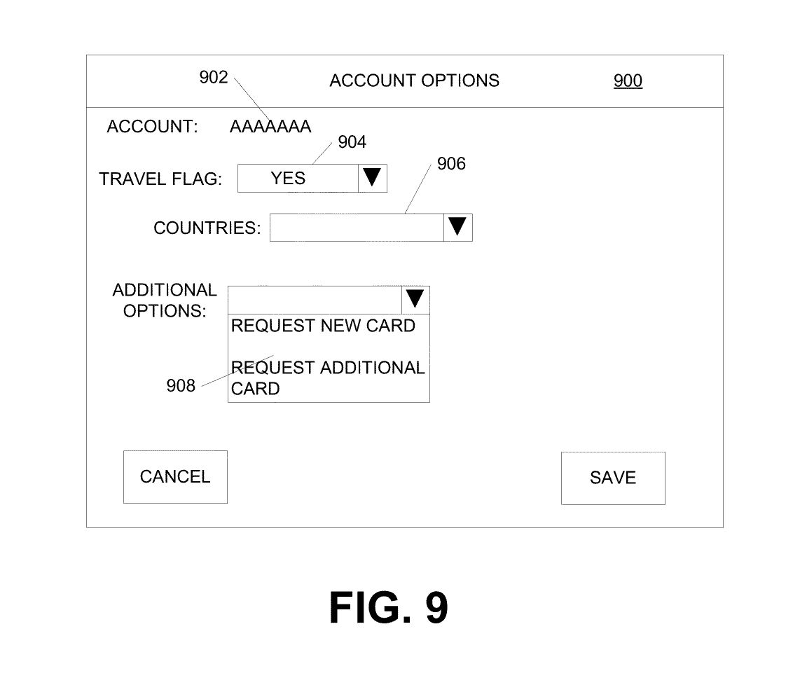

FIG. 9 illustrates a user interface 900 providing additional functionality to a user based on the authentication processes described herein. The interface 900 includes account number field 902. Further, interface 900 provides the user an opportunity to set a travel flag in field 904. As discussed above, a travel flag may be set by a user when the user will be travelling to a country other than his or her home country. Unusual charges from a country other than the user's home country may set off a potential unauthorized use or access warning to the financial institution or other entity managing the account. Accordingly, the user may set a travel flag for the countries in advance of the trip to avoid any potential unauthorized use warnings arising, which may delay completion of one or more transactions.

In field 906, the user may identify one or more countries for which the travel flag should be set. In some examples, the countries may be selected from a list of options accessible, for instance, via a drop-down menu by clicking the arrow in field 906. Alternatively, the user may insert the name or names of the country or countries in field 906.

The user interface 900 may include one or more additional fields, such as field 908, which may provide additional options to the user. For instance, in field 908, provides the user with options for requesting a new card, such as a credit or debit card, or an additional card. In some examples, these additional options may be provided in another, separate user interface. Any additional options selected may be selected, for instance, from a drop down menu. Once the user has made the desired selections, “SAVE” option may be selected. Alternatively, the user may select “CANCEL” option to clear any selections made and/or return to a previous user interface.

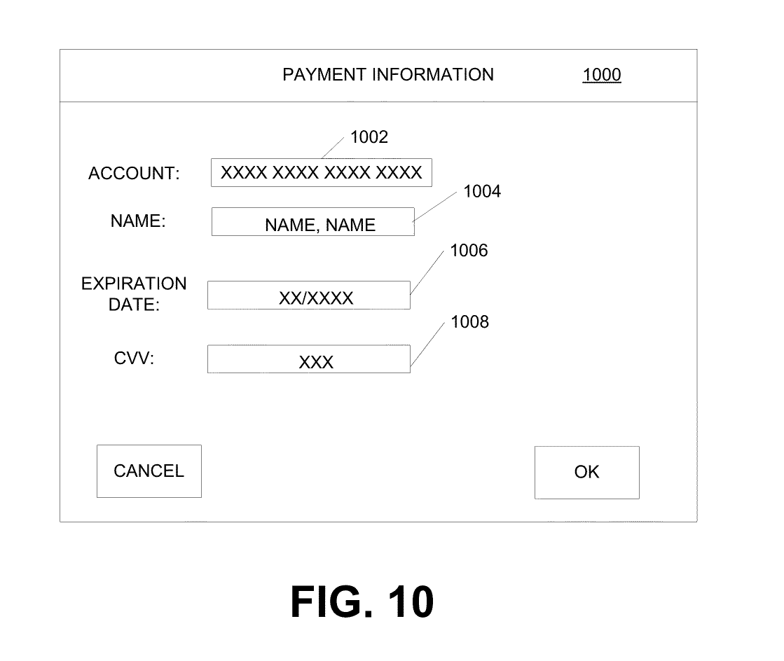

FIG. 10 illustrates yet another example user interface 1000 in which the user information is pre-populated based on the authentication of the user using the machine-readable code and computing device. For instance, if a user is making a payment or completing a transaction, such as an online transaction, with a reusable payment device, the user may capture the machine-readable code on the reusable payment device with a computing device, such as a mobile phone, and, upon determining that the user associated with the mobile device matches the user associated with the reusable payment device, the payment information may be pre-populated. That is, information such as the account number 1002, name of the user 1004, expiration date 1006 of the reusable payment device and/or CVV number 1008 of the reusable payment device may be automatically populated in the payment information fields without additional user input or authentication. In some examples, as discussed above, a proxy number may be generated and may be used in place of the actual account number in field 1002.

Then information illustrated as being pre-populated in FIG. 10 are merely some examples of information that may be pre-populated based on authentication as described herein. Additional information, such as billing address, amount of payment, and the like, may also be pre-populated.

As discussed above, a user may be authenticated based on a machine-readable code arranged on a reusable payment device associated with the user being captured by a computing device associated with the same user. The likelihood of both the reusable payment device associated with a user and the mobile device of the user being used, together, by a person other than the user (e.g., an unauthorized user) is unlikely. Accordingly, the matching of the machine-readable code captured from the reusable transaction device by the mobile device of the user indicates that the user has possession of both devices, thereby serving to authenticate the user. This is an efficient and effective method of authenticating the user in order to provide information or features to the user.

As discussed herein, a user may request to access account information via a computing device, such as a mobile device. The authentication processes discussed herein may provide an efficient manner of authenticating the user to provide access to the requested information or features.

The authentication processes described herein using a machine-readable code and computing device may aid in reducing risk to financial institutions. That is, an image of a machine-readable code from a reusable payment device captured by a computing device of the user associated with the reusable payment device may provide validation to a merchant during, for example, an online transaction or other transaction in which the reusable payment device itself is not present (e.g., may be equivalent to or nearly equivalent to a user presenting the reusable payment device itself). Accordingly, this validation may reduce risk to the financial institution associated with the account of the reusable payment device.

In still other examples, the machine-readable code may be linked or tied to an identifier. The identifier may then be linked to user information or account information of the user associated with the reusable transaction device having the machine-readable code. Accordingly, this may add an additional layer of security because use of the machine-readable code, or unauthorized access to the machine-readable code, would not provide access directly to the account information. Rather, it would only provide access to the additional identifier. Thus, if a user is conducting a transaction in public, any information viewable around the user would not be the actual account information.

In still other examples, the reusable payment device or account associated therewith may include information or links to one or more rewards programs, customer incentives, promotional deals, and the like, at one or more merchants, retails or the like. For instance, a user account may include various promotions and the like for which the user may be eligible. Accordingly, in some examples, upon scanning the machine-readable code with the computing device of the user, one or more promotions available to the user may be presented to the user (e.g., via the computing device). Scanning the machine-readable code on a reusable payment device may provide a quick and efficient way to identify promotions available, apply promotions, and the like.

In some examples, the promotion may be automatically applied if certain criteria are met. For instance, if a user is conducting a transaction involving a purchase at a merchant for which the user has a promotion, the promotion may be automatically applied to the transaction upon scanning the machine-readable code with the computing device. Alternatively, the user may be prompted with an option presenting the promotion and asking for user input to apply the promotion or save until a later date.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure. Further, one or more aspects described with respect to one figure or arrangement may be used in conjunction with other aspects associated with another figure or portion of the description.

What is claimed is:

1. An apparatus, comprising:
at least one processor; and
a memory storing computer-readable instructions that, when executed by the at least one processor, cause the apparatus to:
receive an image of a machine-readable code arranged on a reusable payment device from a computing device;
determine whether the computing device from which the image is received is associated with a user associated with at least one of: the machine-readable code and the reusable payment device;
responsive to determining that the computing device from which the image is received is associated with the user associated with at least one of the machine-readable code and the reusable payment device, provide at least one of: account information for an account associated with the reusable payment device or account functionality to the user; and
responsive to determining that the computing device from which the image is received is not associated with the user, request additional authentication information from the user.

2. The apparatus of claim 1, wherein the determining whether the computing device from which the image is received is associated with a user associated with at least one of: the machine-readable code and the reusable payment device authenticates the user.

3. The apparatus of claim 1, wherein providing at least one of account information or account functionality is performed without additional authentication of the user.

4. The apparatus of claim 1, further including instructions that, when executed, cause the apparatus to:
retrieve account information associated with the user from a database storing account information of a plurality of users.

5. The apparatus of claim 1, further including instructions that, when executed, cause the apparatus to:
receive, from the computing device, an identifier of the computing device,
wherein determining whether the computing device from which the image is received is associated with a user associated with at least one of: the machine-readable code and the reusable payment device includes matching a user associated with the identifier of the computing device to a user associated with the reusable payment device.

6. The apparatus of claim 1, wherein the reusable payment device is one of a credit card and a debit card.

7. The apparatus of claim 1, wherein the machine-readable code is a quick response (QR) code.

8. The apparatus of claim 1, wherein the account information includes at least one of: an outstanding balance on the account, an interest rate associated with the account, a credit limit of the account and a transaction history of the account.

9. The apparatus of claim 1, wherein the account functionality includes at least one of: activating the reusable payment device, deactivating the reusable payment device, setting a travel flag for the account associated with the reusable payment device, requesting a replacement reusable payment device, requesting an additional reusable payment device, and identifying incentives available to the user associated with the reusable payment device.

10. The apparatus of claim 1, wherein the computing device is a mobile device.

11. The apparatus of claim 1, wherein the requested additional authentication information includes a user identifier and password.

12. One or more non-transitory computer-readable media having computer-executable instructions stored thereon that, when executed, cause at least one computing device to:
receive an image of a machine-readable code arranged on a reusable payment device from a mobile computing device;
determine whether the mobile computing device from which the image is received is associated with a user associated with at least one of: the machine-readable code and the reusable payment device;
responsive to determining that the mobile computing device from which the image is received is associated with the user associated with at least one of the machine-readable code and the reusable payment device, provide at least one of: account information for an account associated with the reusable payment device or account functionality to the user; and
responsive to determining that the mobile computing device from which the image is received is not associated with the user, request additional authentication information from the user.

13. The one or more non-transitory computer-readable media of claim 12, wherein the determining whether the mobile computing device from which the image is received is associated with a user associated with at least one of: the machine-readable code and the reusable payment device authenticates the user.

14. The one or more non-transitory computer-readable media of claim 12, further including instructions that, when executed, cause the apparatus to:
receive, from the mobile computing device, an identifier of the mobile computing device,
wherein determining whether the mobile computing device from which the image is received is associated with a user associated with at least one of: the machine-readable code and the reusable payment device includes matching a user associated with the identifier of the mobile computing device to a user associated with the reusable payment device.

15. The one or more non-transitory computer-readable media of claim 12, wherein the account information includes at least one of: an outstanding balance on the account, an interest rate associated with the account, a credit limit of the account and a transaction history of the account.

16. The one or more non-transitory computer-readable media of claim 12, wherein the account functionality includes at least one of: activating the reusable payment device, deactivating the reusable payment device, setting a travel flag for the account associated with the reusable payment device, requesting a replacement reusable payment device, requesting an additional reusable payment device, and identifying incentives available to the user associated with the reusable payment device.

17. An apparatus, comprising:
at least one processor; and
a memory storing computer-readable instructions that, when executed by the at least one processor, cause the apparatus to:
receive a request for payment during a transaction;
receive, from a computing device, an image of a machine-readable code on a reusable payment device being used for payment during the transaction;
based on the received image of the machine-readable code, determine whether the computing device from which the image is received is associated with a user associated with the reusable payment device;
responsive to determining that the computing device is associated with the user of the reusable payment device, pre-populating at least a portion of payment information requested during the transaction, wherein the payment information pre-populated is information associated with the reusable payment device of the user.

18. The apparatus of claim 17, wherein the payment information includes at least one of: an account number of an account associated with the reusable payment device and an expiration date of the reusable payment device.

19. The apparatus of claim 17, further including instructions that, when executed, cause the apparatus to:
generate a proxy number linked to an account number associated with the reusable payment device;

20. The apparatus of claim 19, wherein the pre-populating includes providing the proxy number instead of the account number of the account associated with the reusable payment device as payment information.

21. The apparatus of claim 20, wherein the payment is processed using the proxy number.
